(19) United States
(12) Patent Application Publication
(10) Pub. No.: US 2017/0249218 A1
(43) Pub. Date: Aug. 31, 2017

(54) DATA TO BE BACKED UP IN A BACKUP SYSTEM

(71) Applicant: HEWLETT PACKARD ENTERPRISE DEVELOPMENT LP, Houston, TX (US)

(72) Inventors: David Malcolm FALKINDER, Stoke Gifford Bristol Avon (GB); Richard Phillip MAYO, Stoke Gifford Bristol Avon (GB)

(73) Assignee: HEWLETT PACKARD ENTERPRISE DEVELOPMENT LP, Houston, TX (US)

(21) Appl. No.: 15/329,895

(22) PCT Filed: Sep. 18, 2014
(86) PCT No.: PCT/US2014/056347

§ 371 Date: Jan. 27, 2017

(51) Int. Cl. G06F 11/14; G06F 17/30

(52) U.S. Cl. CPC G06F 11/1453; G06F 17/30958; G06F 11/1451; G06F 2201/84

(57) ABSTRACT

Examples include splitting a non-leaf node of a directed acyclic graph (DAG) in response to determinations that a content-defined fingerprint of a data portion is a breakpoint value and that a target insertion point is between two leaf nodes having a common non-leaf node parent, and determination of whether the data portion was previously stored in a backup system based on the DAG.

### BACKGROUND

A computer system may generate a large amount of data, which may be stored locally by the computer system. Loss of such data resulting from a failure of the computer system, for example, may be detrimental to an enterprise, individual, or other entity utilizing the computer system. To protect the data from loss, a data backup system may store at least a portion of the computer system's data. In such examples, if a failure of the computer system prevents retrieval of some portion of the data, it may be possible to retrieve the data from the backup system.

### BRIEF DESCRIPTION OF THE DRAWINGS

The following detailed description references the drawings, wherein:

FIG. 1 is a block diagram of an example backup system to update and compare a directed acyclic graph (DAG) to a previously stored DAG to determine if a data portion has previously been stored;

FIGS. 2A-2E are diagrams of example DAGs representing data to be backed up in a backup system;

FIG. 3 is a flowchart of an example method for inserting, in a DAG, a target leaf node representing a target data portion to be backed up in the backup system;

FIG. 4 is a block diagram of an example backup environment including an example backup system to store data portions determined not to be previously stored in the backup system based on comparison of an updated DAG with a previously stored DAG; and

FIG. 5 is a flowchart of an example method for providing data portions to a remote backup system for storage based on comparison results

### DETAILED DESCRIPTION

Techniques such as data de-duplication may enable data to be stored in a backup system more compactly and thus more cheaply. By performing de-duplication, a backup system may generally store each unique portion (or “chunk”) of a collection of data once. In some examples, a backup system may perform de-duplication on the basis of content-based fingerprints, such as hashes, of the content of data portions to be backed up. In such examples, the backup system may compare respective hashes of data portions provided for backup to hashes of previously stored data portions to determine which of the provided data portions have not been previously stored in the backup system and thus are to be stored in the backup system.

For efficient comparison of the hashes, a backup system may store hashes of previously stored data portions in a fingerprint-based directed acyclic graph (DAG) data structure comprising nodes and pointers between the nodes. In examples described herein, a fingerprint-based DAG represents data portions in leaf nodes of the DAG organized in a sorted order based on the data portions they represent, with each leaf node including a representative content-based fingerprint (e.g., hash) of the data portion is represents, and each non-leaf node including a representative content-based fingerprint (e.g., hash) representing the content of each child sub-DAG (or sub-tree) under it.

To perform de-duplication, a backup system may construct a new fingerprint-based DAG to represent data portions provided for backup in the backup system, and the backup system may compare the new DAG to a previously stored DAG to determine which of the provided data portions have been stored previously. In such examples, when two DAGs represent the same data with the same structure, then the representative fingerprints will be the same for the two DAGs, from the leaf nodes up through the non-leaf nodes to the root of the DAG. In such examples, a determination that the representative fingerprint of a root node of a new DAG representing data provided for backup is equivalent to a representative fingerprint of a previously stored DAG representing previously stored data portions is sufficient to determine that all of the provided data portions have previously been backed up in the backup system. Even where some differences exist, efficiencies may be gained by identifying identical sub-DAGs based on the representative fingerprints of non-leaf nodes.

In such examples, differently structured DAGs (e.g., having different groups of leaf nodes under respective non-leaf nodes, different collections of non-leaf notes, etc.) will result in different fingerprint values in non-leaf nodes up the DAG, even when the DAGs represent the same data portions. As such, de-duplication efficiency gains may be obtained when similar groups of data portions are represented in similarly-structured DAGs.

However, in some examples, the manner in which fingerprint-based DAGs are constructed may lead to differently structured DAGs being created to represent the same collection of data portions, when those data portions arrive in different order from one time to the next (e.g., different days of performing backup operations). For example, some techniques may construct a DAG (or tree) based on rules designed to promote construction of DAGs having well-balanced structures. With such techniques, however, efficiencies gained by using fingerprint-based DAGs for de-duplication may be lost when data arrives at the backup system out of order, as these balance-focused rules may create balanced, but differently structured, DAGs for these same data portions when they arrive in different orders, which may occur for various reasons. For example, when a backup client executes multiple threads concurrently for providing respective data portions to be backed up, the respective speeds of these threads may vary, causing data portions to be written to the backup system in different orders at different times. In such examples, the out of order arrival may mitigate the efficiency gains of de-duplication using fingerprint-based DAGs, when resulting tree structures differ.

To address these issues, examples described herein may perform de-duplication using fingerprint-based DAGs, constructed by creating and splitting non-leaf nodes based on predefined breakpoint values, such that the resulting DAGs tradeoff balanced structure in favor of improved consistency of structure when building trees for data portions arriving out of order. In this manner, examples described herein promote consistency of DAG structure over balance, to gain efficiencies in the de-duplication process.

Examples described herein may acquire a target data portion to be backed up in a backup system, determine a target insertion point in a fingerprint-based DAG for a target leaf node representing the target data portion, and determine whether a content-based fingerprint of the target data portion is one of a predefined set of breakpoint values. In response to determinations that the fingerprint is one of the breakpoint values and that the target insertion point is between two of the other leaf nodes having a common non-leaf node parent, examples described herein may split the common non-leaf node parent into multiple non-leaf nodes, regardless of whether that common non-leaf node parent is full. Such examples may further update the DAG (including inserting the new leaf node under one of the non-leaf nodes resulting from the split), and compare the updated DAG, with or without further updates, to a previously stored DAG to determine whether the target data portion has previously been stored in the backup system.

In this manner, examples described herein may preemptively split a non-leaf node before it becomes full based on a fingerprint of a leaf node to be inserted being a predefined breakpoint value, without waiting for a non-leaf node to become full (or otherwise meet a maximum fill condition) to either create a new non-leaf node or split a non-leaf node. Such splitting of non-leaf nodes preemptively and based on predefined breakpoint values, that are the same each time, may promote consistency in the children of non-leaf nodes of a DAG, improving consistency of DAG structure when data portions arrive out of order.

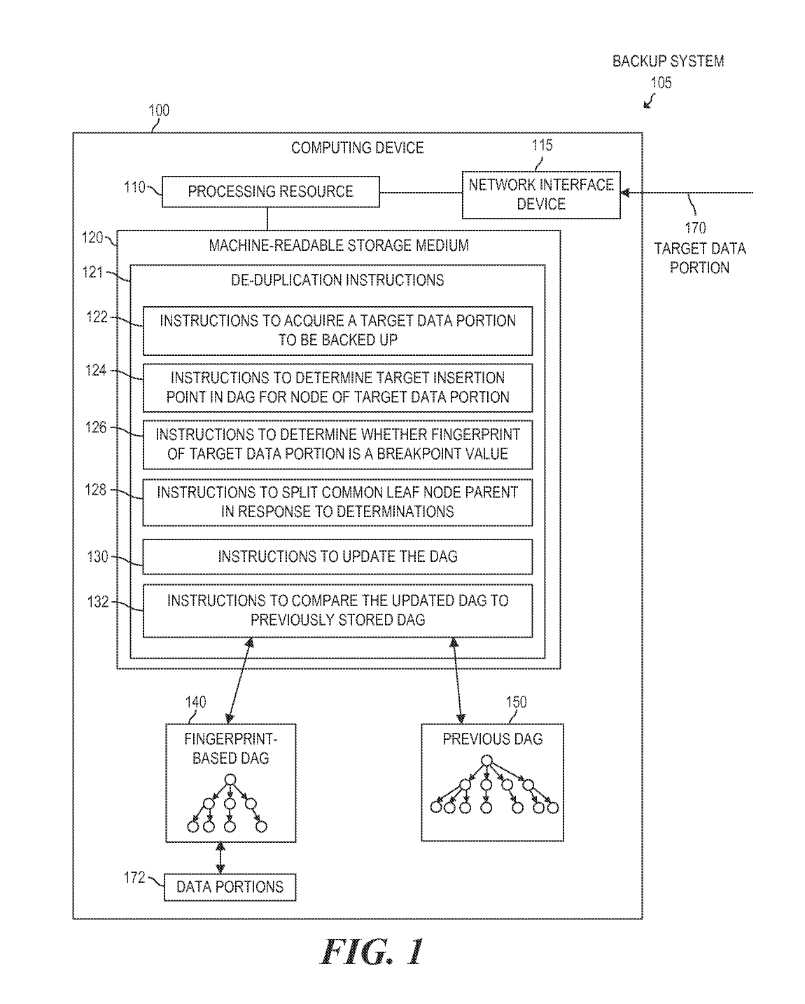

Referring now to the drawings, FIG. 1 is a block diagram of an example backup system 105 to update and compare a fingerprint-based directed acyclic graph (DAG) 140 to a previously stored fingerprint-based DAG 150 to determine if a target data portion 170 has previously been stored in backup system 105.

In the example of FIG. 1, backup system 105 comprises a computing device 100 at least partially implementing backup system 105. Computing device 100 includes a processing resource 110 and a machine-readable storage medium 120 comprising (e.g., encoded with) instructions 121 executable by processing resource 110. In the example of FIG. 1, instructions 121 include at least instructions 122, 124, 126, 128, 130, and 132, to implement at least some of the functionalities described herein in relation to instructions 121. In some examples, storage medium 120 may include additional instructions. In other examples, the functionalities described herein in relation to instructions 121, and any additional instructions described herein in relation to storage medium 120, may be implemented as engines comprising any combination of hardware and programming to implement the functionalities of the engines, as described below.

As used herein, a “computing device” may be a server, blade enclosure, desktop computer, laptop (or notebook) computer, workstation, tablet computer, mobile phone, smart device, or any other processing device or equipment including a processing resource. In examples described herein, a processing resource may include, for example, one processor or multiple processors included in a single computing device or distributed across multiple computing devices. In the example of FIG. 1, computing device 100 includes a network interface device 115. In examples described herein, a “network interface device” may be a hardware device to communicate over at least one computer network. In some examples, a network interface may be a network interface card (NIC) or the like. As used herein, a computer network may include, for example, a local area network (LAN), a wireless local area network (WLAN), a virtual private network (VPN), the Internet, or the like, or a combination thereof. In some examples, a computer network may include a telephone network (e.g., a cellular telephone network).

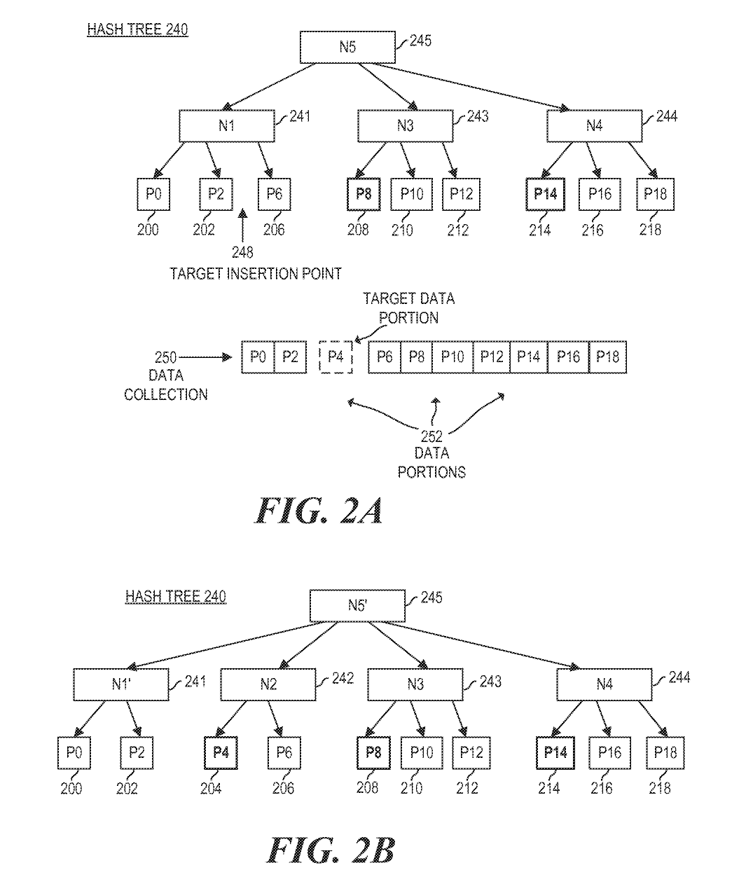

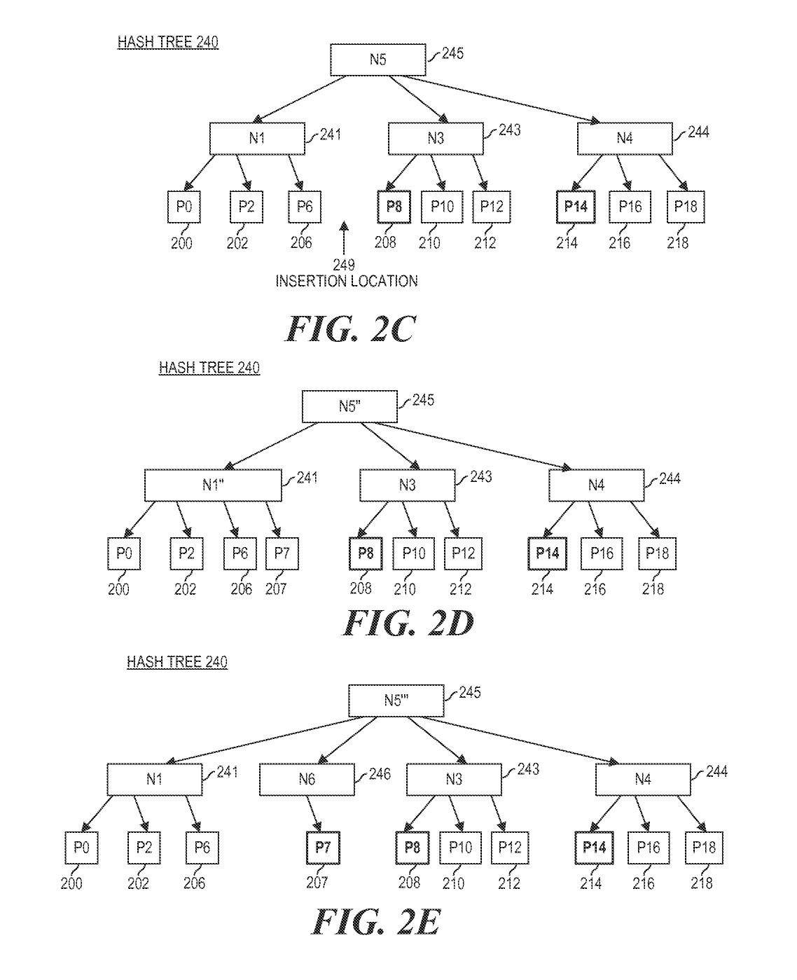

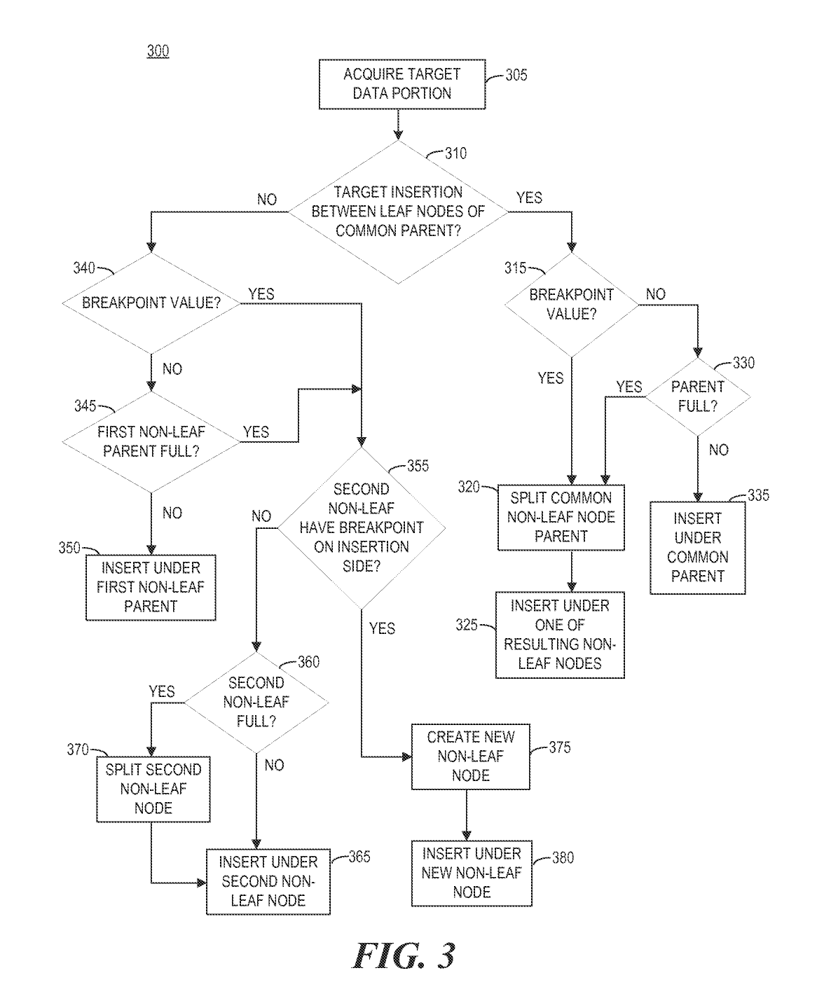

For ease of understanding, examples of de-duplication using fingerprint-based DAGs constructed using breakpoint values will be described herein in relation to FIGS. 1-3. FIGS. 2A-2E are diagrams of example DAGs representing data to be backed up in a backup system. FIG. 3 is a flowchart of an example method 300 for inserting, in a DAG, a target leaf node representing a target data portion to be backed up in the backup system. However, in some examples, computing device 100 of FIG. 1 may perform other methods different than method 300 of FIG. 3 or a subset of method 300, and method 300 of FIG. 3 may be performed by computing device(s) or system(s) other than computing device 100 of FIG. 1.

In the example of FIG. 1, instructions 122 may actively acquire (e.g., retrieve, etc.) or passively acquire (e.g., receive, etc.) data portions 172 and a target data portion 170 to be backed up in backup system 105. Instructions 122 may acquire the data portions via network interface device 115, either directly or indirectly (e.g., via one or more intervening components, services, processes, or the like, or a combination thereof). Instructions 122 may acquire the data portions from a backup client computing device providing data to be backed up at backup system 105, from another computing device of backup system 105, or the like.

Instructions 121 may construct a fingerprint-based DAG 140 to represent data portions acquired for backup in backup system 105. The DAG 140 may be stored in memory of computing device 100, implemented by at least one machine-readable storage medium. The acquired data portions may be part of a larger collection of data (or “data collection”) provided or being provided to backup system 105 for backup. In examples described herein, a collection of data is an ordered sequence of data. The order of the sequence may be represented by any suitable type of metadata, such as offsets of data portions within the collection of data. In some examples, the various data portions may be acquired in larger blocks of data, and divided into the data portions (e.g., chunked from the larger sequence) by instructions 121. As an example, each data portion or chunk may have a mean size of about 4-8 kilobytes (KB). In other examples, data portions or chunks may be of any other suitable size.

In examples described herein, instructions 121 may construct DAG 140 such that it comprises non-leaf node(s) with pointers to child node(s), and leaf node(s) each representing one of the data portions and having a parent non-leaf node that points to the leaf node. Each leaf node may comprise a representative content-based fingerprint (or “representative fingerprint”), which is a content-based fingerprint of the data portion represented by that leaf node. In examples in which the representative fingerprint is a hash, the representative fingerprint may be referred to as a representative hash (or “hash”) of the leaf node. Each non-leaf node may comprise a representative content-based fingerprint that represents of the content of each child sub-tree under it. In examples in which the content-based fingerprints are hashes, the representative content-based fingerprint may be referred to as a representative hash of the non-leaf node. In examples described herein, instructions 121 may create and update the DAG 140 such that each non-leaf node has no more than one direct child leaf node having a representative content-based fingerprint that is one of a plurality of predefined breakpoint values, described below. In this manner, examples described herein may promote consistent DAG structure when data portions are inserted into the tree out of order.

As an example, referring to FIG. 2A, a collection of data (or “data collection”) 250 may comprise a plurality of data portions 252, each having a respective offset value representing its position in the collection of data 250 (and the relative order of data portions 252 in the collection of data 250). In some examples, data portions 252 may be chunks into which at least a portion of data collection 250 has been divided for de-duplication and backup in backup system 105. For example, data collection 250 may be acquired by computing device 100 in larger blocks than the data portions, then divided into the data portion (e.g., chunks) for de-duplication by instructions 121. In the example of FIG. 2A, the data portions 252 may have at least the following relative order based on offset values: P0, P2, P4, P6, P8, P10, P12, P14, P16, P18. In some examples, there may be additional data chunks in collection of data 250, ordered after P18, before P0, between adjacent data portions 252 illustrated in FIG. 2A, or a combination thereof. For example, in addition to data portion P4, other data chunks may occur between data portions P2 and P6.

In example of FIG. 2A, instructions 122 may acquire data portions 252 of data collection 250 via network interface device 115. Instructions 121 may build a fingerprint-based DAG 140 to represent data portions 252 as they are acquired. In the example of FIG. 2A, the fingerprint-based DAG 140 may be a hash tree 240, as an example. In other examples, DAG 140 may be any other type of fingerprint-based DAG. In such examples, the fingerprints may be hashes, and the DAG may be a tree. In examples described herein, a fingerprint-based DAG may be referred to herein as a hash-based DAG when the content-based fingerprint is a hash. In some examples, a fingerprint-based DAG may be a fingerprint-based tree such as a hash tree or Merkel tree.

Instructions 121 of backup system 105 are discussed below with reference to examples of FIGS. 2A-3. Referring to the example of FIG. 2A, instructions 122 may acquire sections of data collection 250 including data portions P0, P2, P6, P8, P10, P12, P14, P16, and P18, and instructions 121 may construct hash tree 240 of FIG. 2A to represent those data portions. Instructions 121 may construct hash tree 240 such that it comprises non-leaf node(s) with pointers to child node(s), and leaf node(s) each having a parent non-leaf node that points to the leaf node. The hash tree 240 may be defined such that each non-leaf node has a maximum number of children (e.g., a maximum fan out). In the examples of FIG. 2A-2E, the maximum number of children is four (for ease of illustration). In other examples, a DAG or tree may have any other suitable maximum number of children (e.g., 512, etc.).

In such examples, hash tree 240 may be constructed to comprise leaf nodes 202, 206, 208, 210, 212, 214, 216, and 218 to represent, respectively, the data portions P0, P2, P6, P8, P10, P12, P14, P16, and P18, in hash tree 240 in a sorted order based on the respective offset values of the data portions. For example, the sorted order of these data portions, based on their respective offset values, is P0, P2, P6, P8, P10, P12, P14, P16, and P18. Instructions 121 may construct hash tree 240 with the leaf nodes placed in the hash tree in the sorted order 202, 206, 208, 210, 212, 214, 216, and 218, based on the offset values of the respective data portions they represent.

In examples described herein, instructions 121 may create and update the hash tree 240 such that each non-leaf node has no more than one direct child leaf node having a representative hash (i.e., content-based fingerprint) that is one of a plurality of predefined breakpoint values, described below. For example, hash tree 240 of FIG. 2A may be constructed as follows when the data collection 250 arrives in order except for at least data portion P4 ordered between P2 and P6, which arrives last. Further, in this example, the representative hashes of data portions P4, P8, and P14 are breakpoint values, while the representative hashes of the rest of the data portions are not. Breakpoint values are described in more detail below.

When building the tree, instructions 121 insert leaf nodes 200, 202, 206, representing P0, P2, and P6, respectively, under a first non-leaf node 241, and create a new non-leaf node 243 as a parent for a leaf node 208 representing P8 (shown in bold) since the representative hash of data portion P8 is a breakpoint value. Instructions 121 also create a common non-leaf node parent 245 for non-leaf nodes 241 and 243. Instructions 121 insert leaf nodes 210 and 212 representing P10 and P12, respectively, under non-leaf node 243 since it is not full and they do not include breakpoint values, and create a new non-leaf node 244 as a parent for a leaf node 214 representing P14 (shown in bold), since the representative hash of data portion P14 is a breakpoint value. Instructions 121 further insert leaf nodes 216 and 218 representing P16 and P18 under node 244 since it is not full and they do not include breakpoint values.

In examples described herein, each leaf node of a fingerprint-based DAG (e.g., hash tree) comprises, for the data portion it represents, at least an offset position of the data portion in a collection of data, and a representative content-based fingerprint of the data portion (e.g., a hash of the data portion). In examples described herein, the representative content-based fingerprint of a data portion may be data derived from the data of the portion itself such that the derived data identifies the data portion it represents and is distinguishable, with a very high probability, from similarly-derived content-based fingerprints for other similarly-sized data portions (i.e., very low probability of collisions for similarly-sized data portions). For example, a fingerprint may be derived from a data portion using a fingerprint function. A content-based fingerprint may be derived from a data portion using any suitable fingerprinting technique (e.g., Rabin fingerprinting technique, etc.). In some examples, the content-based fingerprints may be hashes derived from data portions using any suitable hash function (e.g. SHA-1, etc.). In the example of FIG. 2A, each of the leaf nodes comprises a representative hash of the data portion it represents (which may be referred to as that leaf node's hash). For example, leaf node 200 comprises a representative hash that is a hash of data portion P0 (e.g., h(P0), where “h( )” represents a hash function), leaf node 202 comprises a representative hash that is a hash of data portion P2 (e.g., h(P2)), etc.

In examples described herein, each non-leaf node of a fingerprint-based DAG (e.g., hash tree, etc.) comprises a representative content-based fingerprint (e.g., hash, etc.) representing the content of each child sub-DAG (e.g., sub-tree) under it. In the example of FIG. 2A, hash tree 240 comprises non-leaf nodes 241, 243, 244, and 245, and each non-leaf node comprises a representative hash representing the content of each child sub-tree under it. For example, non-leaf node 241 comprises a representative hash N1 representing leaf nodes 200, 202, and 206 (i.e., it's child sub-trees). The instructions 121 may construct the non-leaf node representative hashes such that the representative hashes of two non-leaf nodes with identical child sub-trees have the same representative hashes. In this manner, examples described herein may enable efficient comparison of data portions by comparing the representative hashes of nodes of hash trees (or comparing representative fingerprints of nodes of fingerprint-based DAGs). As an example, the instructions 121 may calculate the representative hash of each non-leaf node by hashing data comprising the representative hashes of its direct children.

For example, representative hash N1 may be derived from hashing a concatenation of at least the representative hashes of its child nodes 200, 202, 206 (e.g., N1=h(h(P0)+h(P2)+h(P6)), where “+” represents concatenation). In other examples, further information may be concatenated with the child representative hashes to create the non-leaf node hash, such as the offsets of the leaf nodes (e.g., N1=h(P0_offset+h(P0)+P2_offset+h(P2)+P6_offset+h(P6))). In some examples, while the leaf nodes are stored in the tree in sorted order relative to their overall offsets in a data collection, the offsets stored in a leaf node may be relative offsets based on its relative position under its parent non-leaf node. In examples described herein, in addition to their hashes, non-leaf nodes may also comprise information indicating the range of offsets stored under the non-leaf node, which may be utilized to determine where to insert a new leaf node representing a data portion having a given offset. In some examples, the representative hash of a non-leaf node with non-leaf node children may be a hash of data including the representative hash(es) of its non-leaf node children. For example, the representative hash N5 of node 245 may be h(N1+N3+N4). In other examples, other data may be combined (e.g., concatenated) with the other hashes before hashing, as for the offset data described above.

Examples of inserting a subsequent target data portion are described below in relation to FIG. 1, 2A, and method 300 of FIG. 3. In particular, an example of inserting an example target data portion P4 in hash tree 240 representing other data portions 252 (see FIG. 2A) is described below in relation to FIG. 3. In such examples, at 305 of method 300, instructions 122 may acquire target data portion P4 to be backed up in backup system 105 (an example of target data portion 170).

At 310 of method 300, instructions 124 may determine a target insertion point, in hash tree 240, for a target leaf node representing target data portion 170. In examples described herein, a target insertion point is a location in a hash tree or other fingerprint-based DAG where a target leaf node is to be inserted. In such examples, instructions 124 may determine a target insertion point 248 for a target leaf node representing target data portion P4, based on at least the offset of target data portion P4 within data collection 250, the offset ranges of the non-leaf nodes of hash tree 240, and the offsets of the leaf nodes of hash tree 240. For example, based on the offsets, instructions 124 may determine that the target leaf node is to be inserted between leaf nodes 202 and 206 (representing data portions P2 and P6, respectively), which have a common non-leaf node parent, namely non-leaf node 241. As such, in the example of FIG. 2A, instructions 124 may determine that target insertion point 248 for the target leaf node is between two of leaf nodes (i.e., 202 and 206) having a common non-leaf node parent (i.e., 241). By inserting the target leaf node representing target data portion P4 between the leaf nodes representing data portions P2 and P6, the sorted order of the leaf nodes of hash tree 240 based on the offset values may be maintained.

In response to a determination that target insertion point 248 is between leaf nodes of a common non-leaf node parent, method 300 may proceed to 315, where instructions 126 may determine whether the hash (i.e., content-based fingerprint) of target data portion P4 is one of a predefined plurality of breakpoint values. As used herein, a “breakpoint value” is one of a predefined set of values treated differently than other content-based fingerprint values in the process of constructing and updating a fingerprint-based DAG to promote consistency of DAG structure when insertion order varies.

In examples described herein, the plurality of breakpoint values may be defined in any suitable manner to promote consistency of DAG structure when insertion order varies. For example, examples described herein may use breakpoint values to determine when to preemptively split a node or create a new node, before maximum child (or fan out) conditions would cause such a node split or creation. Such techniques may promote consistency in the children of non-leaf nodes of a fingerprint-based DAG when the children are inserted in different orders. To provide this consistency, examples described herein may define the breakpoint values such that breakpoint values are encountered in constructing a fingerprint-based DAG much more frequently than node creations or splits are caused by nodes being full (e.g., having the maximum number of children).

For each data portion to be represented in a fingerprint-based DAG, examples described herein determine whether the content-defined fingerprint of the data portion is a breakpoint value. As such, the breakpoint value may be defined such that content-based fingerprint values are determined to be breakpoint values much more frequently than a node full condition (e.g., maximum child node condition) is reached. For example, if a number of child nodes allowed for a given non-leaf node is 512 nodes, then the plurality of breakpoint values may be defined such that one out of every 256 content-based fingerprint values is a breakpoint value. In this way, examples described herein would be much more likely to split or create new non-leaf node preemptively based on breakpoint values than based on a non-leaf node being full (maximum child node condition), thereby promoting consistency of DAG structure.

The plurality of predefined breakpoint value may be defined in any suitable manner. As an example, the plurality of predefined breakpoint values may be defined as a set of values that have a predetermined sequence of bits in a predetermined location (i.e., range of bits). For example, in some examples, instructions 121 may utilize a fingerprint function producing multiple-byte fingerprint values (e.g., 20-byte hash values) for use in fingerprint-based DAGs for de-duplication. In such examples, the predefined breakpoint values may be defined as the plurality of fingerprint values (e.g., hash values, etc.) having the sequence “11111111” as the first eight bits (i.e., 0xFF in the first byte). In such examples, given at least a relatively uniform distribution of fingerprint values from the fingerprint function, about one out of every 256 fingerprint values would be expected to be a breakpoint value.

In such examples, instructions 121 may examine the first byte of a fingerprint value (e.g., hash value) to determine whether the fingerprint value is breakpoint value. For example, instructions 121 may determine that, each fingerprint having a binary value of “11111111” in the first byte is determined to be a breakpoint value, and such that each fingerprint having any other value in the first byte is determined not to be a breakpoint value. Although explanatory examples have been given above, breakpoint values may be defined and determined in any other suitable ways, including use of different fingerprint functions, fingerprint lengths, bit or byte pattern(s) used to define and detect breakpoint values, etc.

Returning to FIG. 3 and the example of FIG. 2A, at 315 of method 300, instructions 126 may determine whether the hash (i.e., content-based fingerprint) of target data portion P4 is one of the predefined plurality of breakpoint values, as described above. In examples in which the hash of target data portion P4 is a breakpoint value, then in response to a determination at 315 that the hash of target data portion P4 is one of the breakpoint values, method 300 may proceed to 320, where instructions 128 may split common non-leaf node parent 241 into multiple non-leaf nodes, as illustrated in FIG. 2B. Since node 241 is not full (i.e., does not have the maximum number of children, which is four in this example) the breakpoint value causes a preemptive split to promote consistency of tree structure, as described above. That is, in response to determinations that the hash of target data portion P4 is one of the breakpoint values and that target insertion point 248 is between leaf nodes with a common non-leaf node parent, instructions 128 may split common non-leaf node parent 241 into multiple non-leaf nodes (e.g., 241, 242 of FIG. 2B) regardless of whether common non-leaf node 241 is full.

In the example of FIGS. 2A and 2B, instructions 128 may split non-leaf node 241 into nodes 241 and 242. In such examples, instructions 130 may split the children of non-leaf node 241 at the target insertion point 248 wherein the target leaf node for data portion P4 is to be inserted such that, as illustrated in FIG. 2B, leaf nodes 200 and 202 remain children of non-leaf node 241, and leaf node 206 becomes a child of new non-leaf node 242. At 325 of method 300, instructions 130 may update hash tree 240, including inserting the new leaf node under one of the non-leaf nodes resulting from the split, namely under non-leaf node 242 in the example of FIG. 2B. In such examples, after a modification to a hash tree (e.g., new insertion, split, node creation, etc.), instructions 130 may further update the representative hash of each non-leaf node having a child sub-tree that has been modified. For example, instructions 130 may update the tree based on this insertion, including updating the representative hash of non-leaf node 241 to a new hash N1′ representing leaf nodes 200 and 202, creating representative hash N2 of non-leaf node 242, and updating the representative hash of non-leaf node 245 to a new representative hash N5′ to represent the updated sub-trees below node 245 (including the addition of node 242).

After these updates, instructions 132 may compare the updated hash tree 240 of FIG. 2B (with or without further updates) to a previously stored DAG (e.g., DAG 150 of FIG. 1) to determine whether target data portion P4 has previously been stored in persistent storage of backup system 105. In response to a determination that target data portion P4 has not been previously stored in persistent storage of backup system 105, based on previously stored DAG 105, instructions 132 may store target data portion P4 in persistent storage of backup system 105. In some examples described herein, the persistent storage of a backup system is non-volatile storage where data portions are stored for the purpose of persistent backup. For example, such persistent storage may be different than volatile or other working memory used by a backup system 105 to store data (e.g., DAG 140) while performing functions on the data, such as de-duplication, prior to persistent storage of some or all of the data.

As an example, instructions 132 may traverse down the updated hash tree 240 (e.g., of FIG. 2B) starting from the root (e.g., node 245) and, for each traversed node, compare the representative hash of the node to at least one representative hash of at least one node of the previously stored DAG 150 to find the highest level nodes of hash tree 240 that are represented in previously stored DAG 150. In such examples, finding a given node in hash tree 240 having a representative hash matching a representative hash of a node of DAG 150 indicates that the entire sub-tree of the given node has previously been stored in backup system 105, and in response the data portions represented in the sub-tree are not stored again in persistent storage of the backup system. Also, in such examples, if a traversal proceeds all the way to a leaf node of hash tree 240 without finding a match, even for the representative hash of the leaf node, that indicates that the data portion represented by the leaf node has not previously been stored in persistent storage of backup system 105. In response, instructions 132 may store the data portion represented by the not found leaf node in persistent storage of the backup system. In this manner, examples described herein may utilize the fingerprint-based DAGs for data de-duplication in storage system 105.

In examples described herein, instructions 121 may create and update hash tree 240 such that each non-leaf node has no more than one direct child leaf node having a representative hash that is one of the breakpoint values. The examples of FIGS. 2A and 2B illustrate updating hash tree 240 in this manner for a target insertion point between leaf nodes with a common non-leaf node parent. Updating the tree in this manner in accordance with other conditions is described below.

Certain benefits of creating and updating hash trees (or other fingerprint-based DAGs) in this manner may be appreciated with reference to FIGS. 2A and 2B. For example, by creating and updating hash tree 240 such that each non-leaf node has no more than one direct child leaf node having a hash that is one of the breakpoint values may, in accordance with examples described herein, results in hash tree 240 having the same structure whether target data portion P4 arrives out of order (e.g., after all the other data portions), as shown in FIGS. 2A and 2B, or in order (i.e., between P2 and P6).

For example, when the data portions 252 of data collection 250 arrive and are inserted in order (i.e., the order shown for data collection 250), instructions 121 insert the leaf nodes for the data portions in the following manner. Instructions 121 insert leaf nodes 200, 202 representing P0 and P2 under a first non-leaf node 241, and create a new non-leaf node 242 as a parent for the leaf node 204 representing P4, since the hash of data portion P4 is a breakpoint value. Instructions 121 insert leaf node 206 representing P6 under node 242 since 242 is not full and the hash of P6 is not a breakpoint value. Then instructions 121 insert leaf nodes 208, 210, and 212 under a new non-leaf node 243, and insert leaf nodes 214, 216, and 218 under another non-leaf node 244, as described above, based on the hashes of data portions P8 and P14 being breakpoint values, and the maximum number of children being four in this example. As such, in this example, whether data portion P4 arrives in order or out of order, the same tree structure results. As such, the same representative hash values will be present in the non-leaf nodes, providing efficiencies described above when comparing trees during de-duplication.

Benefits of examples described herein may further be appreciated by an illustration of constructing hash trees for these data portions without utilizing breakpoint values as described herein. In such an example, constructing a hash tree for data portions 252 in order (including P4) may result in leaf nodes for the data portions being grouped under non-leaf nodes as follows: {P0, P2, P4, P6}, {P8, P10, P12, P14}, {P16, P18}. In this example, a new non-leaf node (and hence a new grouping of non-leaf nodes) may be created after a current non-leaf node reaches a maximum number of leaf nodes. Alternatively, when data portion P4 arrives last, the leaf-node groupings may be different. For example, the leaf node groups may be as follows before P4 arrives (determined based on filling non-leaf nodes): {P0, P2, P6, P8}, {P10, P12, P14, P16}, {P18}. When P4 arrives, the first non-leaf node may be split so that the leaf node for P4 may be inserted, resulting in the following leaf node groupings under respective non-leaf nodes: {P0, P2}, {P4, P6, P8}, {P10, P12, P14, P16}, {P18}. In this example, when P4 arrives out of order, none of the resulting leaf node groupings are the same as when the data portions arrive in order. As such, none of the representative hashes of the non-leaf nodes will match between the two trees built in these different orders, which is a detriment to de-duplication when, for example, the same data arrives in a first order one day and another order the next.

Returning to FIGS. 1 and 3, examples of insertion by instructions 121 for other insertion conditions are described below. For example, in an example in which the hash of data portion P4 is not a breakpoint value, instructions 124 may determine (at 310 of method 300) that the target insertion point 248 for the target leaf node is between leaf nodes of a common non-leaf node parent, as described above, and instructions 126 may determine (at 315 of method 300) that the hash of target data portion P4 is not one of the breakpoint values (in this example). In such examples, method 300 may proceed to 330 where instructions 121 may determine that the common non-leaf node parent is not full (i.e., less than four children in this example), and may proceed to 335, where instructions 121 may insert the target leaf node under non-leaf node 241 between leaf nodes 202 and 206. In other examples in which non-leaf node 241 is full, method 300 may proceed to 320, where instructions 128 may split non-leaf node 241 and instructions 130 may insert the target leaf node under one of the non-leaf nodes resulting from the split (e.g., a node 242 as in FIG. 2B), at 325 of method 300.

Returning to 305 of method 300, examples of insertion in accordance with other conditions are described below in relation to FIGS. 1, 2C-2D, and 3. For example, returning to the hash tree 240 of FIG. 2A (i.e., before insertion of a leaf node representing a data portion P4), insertion of a target leaf node representing another target data portion P7 will be described below. At 305 of method 300, instructions 122 may acquire a target data portion P7. At 310 of method 300, instructions 124 may determine a target insertion point, in hash tree 240, for a target leaf node representing target data portion P7. In examples described herein, target data portion P7 is a part of data collection 250 (see FIG. 2A), is ordered between data portions P6 and P8, based on offsets for data collection 250, and is acquired and inserted after the acquisition and insertion of the data portions represented in hash tree 240 illustrated in FIG. 2A.

As part of the insertion point determination, instructions 124 may determine that the target leaf node is to be inserted, in the sorted order of the other leaf nodes, at a location 249 between two leaf nodes 206 and 208 having different parent non-leaf nodes (see FIG. 2C). This determination may be based on offsets, as described above. In such examples, the target insertion point will be at an end of one of the different parent non-leaf nodes, and as such, the determination at 310 may alternatively be referred to as a determination of whether the target insertion point will be at an end of one of the different parent non-leaf nodes.

In response to this determination that the target leaf node is to be inserted at a location 249 between two leaf nodes 206 and 208 having different parent non-leaf nodes, method 300 may proceed to 340, where instructions 126 may determine whether a hash of data portion P7 is one of the breakpoint values, as described above. If not, then method 300 may proceed to 345, wherein instructions 121 may determine whether a first one of the non-leaf node parents is full (in this example, whether it contains the maximum of four children). In this example, instructions 121 may first look to the non-leaf node on the left-hand side of the determined insertion location 249, when the insertion location is between leaf nodes having different parents. In other examples, instructions 121 may look first to the non-leaf node on the right hand side of insertion location 249.

In the example of FIG. 2C, instructions 121 may first look to non-leaf node 241, and determine that node 241 is not full. In response to determinations that non-leaf node 241 is not full and that the hash (fingerprint) of target data portion P7 is not one of the breakpoint values, instructions 124 may determine the target insertion point to be under non-leaf node 241. In such examples, instructions 130 may insert a target leaf node 207 representing data portion P7 under non-leaf node 241, as illustrated in FIG. 2D, at 350 of method 300. As illustrated in FIG. 2D, instructions 130 may further update the representative hashes of non-leaf nodes 241 and 245 to N1″ and N5″ such that they represent the new structure of hash tree 240 including node 207, as inserted.

In other examples, instructions 121 may determine that the hash of target data portion P7 is one of the breakpoint values, that the non-leaf node 241 (i.e., the non-leaf node parent looked to first) is full, or both. In response to at least one of a determination that the hash of target data portion P7 is one of the breakpoint values (340 of FIG. 3) and a determination that non-leaf node 241 is full (345 of FIG. 3), instructions 124 may determine target insertion point for target data portion P7 to be under non-leaf node 243 (i.e., the non-leaf node parent looked to second). In response, method 300 may proceed to 355.

In such examples, instructions 130 to update hash tree 240 may determine whether to insert the target leaf node for target data portion P7 under the second non-leaf node, or to create a new non-leaf node for the target leaf node, based on at least one of whether non-leaf node 243 is full and whether non-leaf node 243 has a direct child leaf node with one of the breakpoint values as its hash (i.e., content-based fingerprint of the data portion it represents).

For example, at 355, instructions 126 may determine whether non-leaf node 243 has a direct child leaf node with one of the breakpoint values as its hash. If so, instructions 130 may create a new non-leaf node 246 (375 of FIG. 3), and insert target leaf node 207 under node 246 (380 of FIG. 3), as illustrated in FIG. 2E. As illustrated in FIG. 2E, instructions 130 may further update the representative hash of non-leaf node 245 N5′″ such that it represents the new structure of hash tree 240 including node 207, as inserted. In this manner, instructions 121 may, in response to determinations that the fingerprint of the target data portion is one of the breakpoint values and that the target insertion point at an edge of a non-leaf node having a direct child leaf node with one of the breakpoint values as its content-based fingerprint, create a new non-leaf node 246 and insert target leaf node 207 under the new non-leaf node 246.

Instructions 121 may also determine (at 360 of FIG. 3) whether non-leaf node 243 is full. When instructions 126 determine that non-leaf node 243 does not have a direct child leaf node with one of the breakpoint values as its hash (e.g., if the hash of node 208 were not one of the breakpoint values) and instructions 121 determine that non-leaf node 243 is not full, instructions 130 may insert target leaf node 207 for data portion P7 under non-leaf node 243 (at 365 of FIG. 3). In other examples, when instructions 126 determine that non-leaf node 243 does not have a direct child leaf node with one of the breakpoint values as its hash, and instructions 121 determine that non-leaf node 243 is full, instructions 130 may split non-leaf node 243 at 370 of FIG. 3 (e.g., create a new non-leaf node after node 243 with at least one of the leaf nodes at the right end of node 243), and insert target leaf node 207 for data portion P7 under non-leaf node 243 (at 365 of FIG. 3).

In examples in which instructions 121 implement insertion in accordance with the examples described in relation to FIG. 3, instructions 121 may implement creation and updating of a hash tree (or other fingerprint-based DAG) such that a non-leaf node has no more than one direct child leaf node having a representative hash that is one of the breakpoint values. Also, in accordance with the examples of FIG. 3, instructions 121 may further create and update the tree such that any leaf node having a representative hash that is a breakpoint value is located on a first end of its parent non-leaf node (e.g., the left-hand side of the node), as illustrated in FIGS. 2A-2E, for example. Instructions 121 may also apply splitting based on breakpoint values, as described above, to non-leaf nodes all the way up the tree, such that non-leaf nodes having non-leaf node children have no more than one non-leaf node child having a representative hash that is one of the breakpoint values.

Although, for illustrative purposes, examples are described herein in relation to hashes and hash trees, any other suitable type of content-based fingerprints may be used, and any other suitable type of fingerprint-based DAG may be used. Also, in some examples, DAG 140 may be a hash tree, while DAG 150 is a hash-based DAG, for example. Also, although examples are described herein in which insertion between non-leaf nodes look first to insertion on the left-hand side non-leaf node and maintain nodes having representative hashes on the left-hand end of their parent node, this may be reversed in other examples. In examples described herein, a fingerprint-based DAG may be implemented in any suitable manner. For example, pointers may be memory pointers, pointers to hashes, or the like. Likewise, nodes may be implemented in any suitable manner.

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to perform the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media is part of an article (or article of manufacture). An article or article of manufacture may refer to any manufactured single component or multiple components. The storage medium may be located either in the computing device executing the machine-readable instructions, or remote from but accessible to the computing device (e.g., via a computer network) for execution.

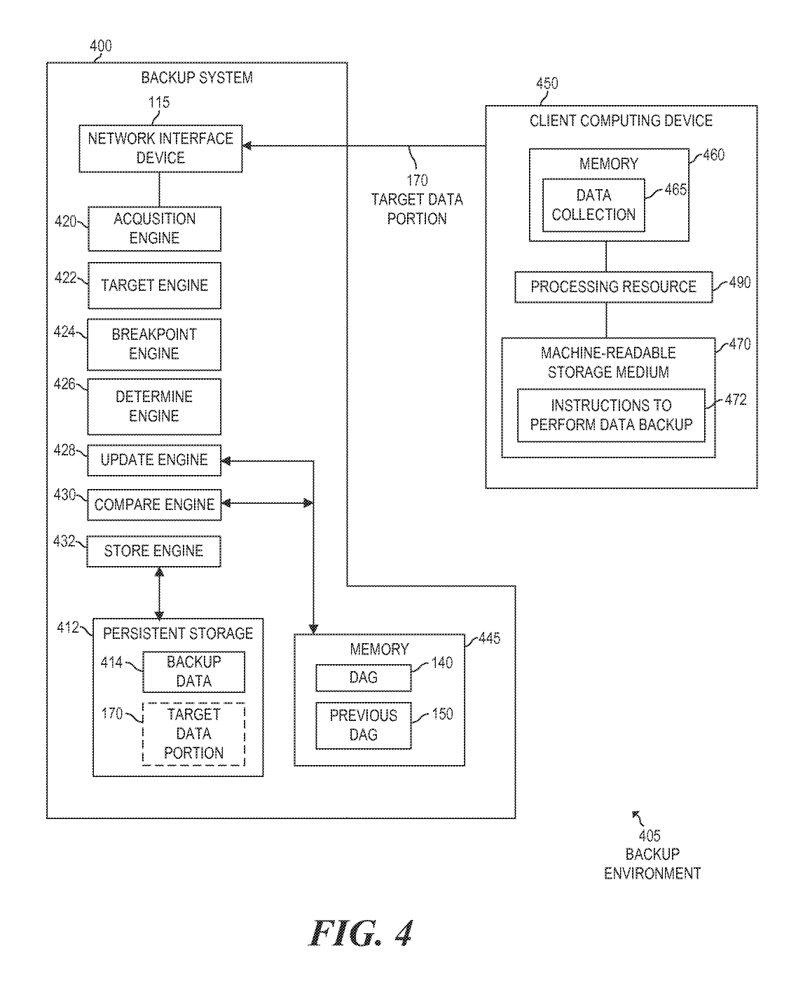

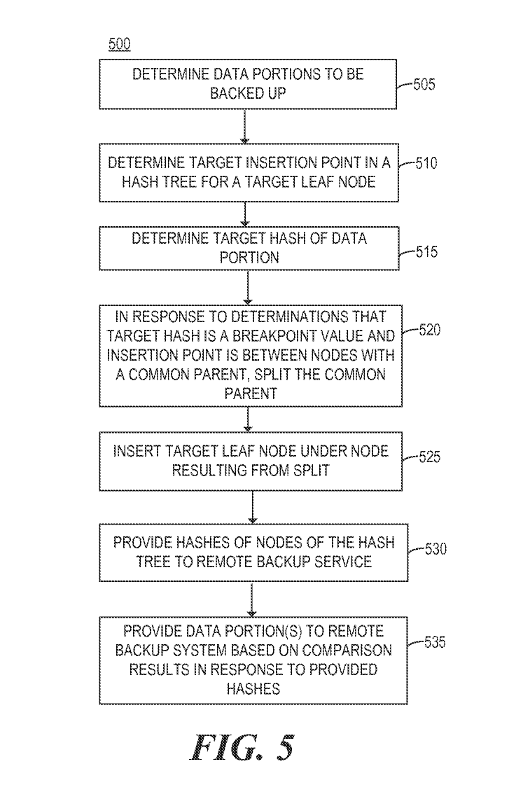

In some examples, instructions 121 may be part of an installation package that, when installed, may be executed by processing resource 110 to implement the functionalities described herein in relation to instructions 121. In such examples, storage medium 120 may be a portable medium, such as a CD, DVD, or flash drive, or a memory maintained by a server from which the installation package can be downloaded and installed. In other examples, instructions 121 may be part of an application, applications, or component(s) already installed on a computing device 100 including processing resource 110. In such examples, the storage medium 120 may include memory such as a hard drive, solid state drive, or the like. In some examples, functionalities described herein in relation to FIGS. 1-3 may be provided in combination with functionalities described herein in relation to any of FIGS. 4-5.

FIG. 4 is a block diagram of an example backup environment 405 including an example backup system 400 to store data portions determined not to be previously stored in backup system 400 based on comparison of an updated DAG with a previously stored DAG. System 400 includes at least engines 420, 422, 424, 426.428, 430, and 432, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In such examples, the at least one machine-readable storage medium may store instructions that, when executed by the at least one processing resource, implement the engines of system 400. In such examples, system 400 may include the at least one machine-readable storage medium storing the instructions and the at least one processing resource to execute the instructions, or one or more of the at least one machine-readable storage medium may be separate from but accessible to system 400 and the at least one processing resource (e.g., via a computer network).

In some examples, the instructions can be part of an installation package that, when installed, can be executed by the at least one processing resource to implement at least the engines of system 400. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on system 400 including the processing resource. In such examples, the machine-readable storage medium may include memory such as a hard drive, solid state drive, or the like. In other examples, the functionalities of any engines of system 400 may be implemented in the form of electronic circuitry.

System 400 also includes a network interface device 115, as described above, a persistent storage 412, and memory 445. In some examples, persistent storage 414 may be implemented by at least one non-volatile machine-readable storage medium, as described herein, and may be memory utilized by backup system 400 for persistently storing data provided to backup system 400 for backup, such as non-redundant (e.g., de-duplicated) data of data collections provided for backup. Memory 445 may be implemented by at least one machine-readable storage medium, as described herein, and may be volatile storage utilized by backup system 400 for performing de-duplication processes as described herein, for example. Storage 412 may be separate from memory 445.

Backup environment 405 may also include a client computing device 450 (which may be any type of computing device as described herein) storing an ordered data collection 465 in memory 460, which may be implemented by at least one machine-readable storage medium. Client computing device may also include a processing resource 490 and a machine-readable storage medium 470 comprising (e.g., encoded with) instructions 472 executable by processing resource 490 to at least provide data collection 465 to backup system 400 for backup.

For example, client computing device 450 may provide data collection 465 to backup system 400 for backup. In such examples, backup system 400 may acquire data collection 460 via network interface device 115, and the engines of system 400 may construct a fingerprint-based DAG 140 to represent the data portions of data collection 465, as described above in relation to FIGS. 1-3. In some examples, client computing device 450 may provide data collection 465 to backup system 400 at least partially out of order, as described above. For example, client computing device 450 may provide a block or region of data collection 465 including a target data portion 170 after other blocks or regions of data collection 465 preceding target data portion 170 in collection 465, and after other blocks or regions of data collection 465 following target data portion 170 in collection 465. In such examples, target data portion 170 is provided out of order. For ease of explanation, examples of FIG. 4 are described herein in relation to FIGS. 2A and 2B.

In such examples, before acquiring target data portion 170, acquisition engine 420 may acquire, with network interface device 115, other data portions of collection 465 to be backed up in the backup system. In such examples, the engines of system 400 may construct a fingerprint-based DAG 140 to represent the other data portions of data collection 465 provided before target data portion 170, as described above in relation to FIGS. 1-3. The DAG 140 may comprise non-leaf nodes and other leaf nodes representing, in a sorted order, the other data portions. For example, referring to FIG. 2A, data collection 250 may be an example of data collection 465, and hash tree 420 of FIG. 2A may be an example of the DAG 140 constructed by the engine of system 400.

After acquiring the other data portions, acquisition engine 420 may acquire, with network interface device 115, target data portion 170 to be backed up in the backup system (e.g., as part of a larger block of data including portion 170). As an example, data portion P4 described above may be the target data portion 170. In such examples, target engine 422 may determine a target insertion point in hash tree 420 for a target leaf node 204 representing target data portion P4, as described above. Breakpoint engine 424 may determine whether a hash (or other content-based fingerprint) of target data portion P4 is one of a predefined plurality of breakpoint values, as described above.

In response to determinations that the hash is one of the breakpoint values and that the target insertion point 248 is between two of the other leaf nodes having a common non-leaf node parent, a determine engine 426 may determine to split the common non-leaf node regardless of whether the common non-leaf node is full. In the example of FIG. 2A, in response to determinations that the hash is one of the breakpoint values and that the target insertion point 248 is between leaf nodes 202 and 206 having a common non-leaf node parent 241, a determine engine 426 may determine to split the common non-leaf node 241 regardless of whether common non-leaf node 241 is full.

In such examples, update engine 428 may update hash tree 240, including inserting target leaf node 207 under one of the non-leaf nodes resulting from the split. In the example of FIGS. 2A and 2B, updating hash tree 240 may include engine 428 inserting target leaf node 207 under non-leaf node 242 resulting from the split. Update engine 428 may further update the representative hash of each non-leaf node having a child sub-tree that has been modified, as illustrated in FIG. 2B.

In some examples, a compare engine 430 may determine which of the target data portion P4 and other data portions of data collection 250 were previously stored in persistent storage 412 of backup system by comparing the representative hashes of one or more non-leaf and leaf nodes of the updated hash tree 240 to representative hashes of nodes of a previously stored fingerprint-based (e.g., hash-based) DAG 150 representing data portions previously stored in persistent storage 412. In some examples, the previously stored DAG 150 may be stored in memory 445 with DAG 140, or in other memory separate from memory 445 (e.g., persistent storage 412).

In some examples, compare engine 430 may compare DAGs 140 and 150 after the updates to insert target data portion P4, either without further updates of DAG 140, or after further updates of DAG 140 (e.g., for insertion of additional data portions, etc.). These comparisons may be performed as described above to determine, for de-duplication, which of the data portions represented in DAG 140 is also represented in previously stored DAG 150 (indicating that it should not be stored again), and which of the data portions represented in DAG 140 is not represented in previously stored DAG 150 (indicating that it is to be stored in persistent storage 412 at this time).

In some examples, comparing the DAGs comprises traversing down the DAG 140 (e.g., hash tree) starting from the root and, for each traversed node, comparing the representative fingerprint (e.g., representative hash) of the node to at least one representative fingerprint (e.g., representative hash) of at least one node of the previously stored DAG to find highest level nodes of DAG 140 that are represented in the previously stored DAG.

Based on the results of the comparisons of the DAGs, store engine 432 may store, in persistent storage 412 of backup system 400, each of the target data portion P4 and the other data portions determined not to be previously stored in the persistent storage 412 of backup system 400 (e.g., as part of backup data 414), and may not store any data portion determine to be previously stored in persistent storage 412. For example, store engine 432 may store a target data portion 170 (such as data portion P4) in persistent storage 412 in response to the comparisons. In some examples, backup system 400 may be implemented by at least computing device, and persistent storage 412 may be part of, or at least partially remote from and accessible to the at least one computing device.

Described above in relation to FIG. 4 is an example of insertion of a target leaf node having a target insertion point between leaf nodes having a common parent when the representative hash of the target leaf node is one of the breakpoint values. In some examples, the engines of system 400 may implement insertion of leaf nodes and updating a DAG in accordance with other conditions, as described above in relation to FIGS. 1-3. In such examples, engines of system 400 may create and update fingerprint-based DAGs in accordance with the example of method 300 of FIG. 3 to thereby create and update DAG (e.g., hash trees) such that each non-leaf node of the DAG has no more than one direct child leaf or direct child non-leaf node whose representative hash is one of the breakpoint values. In such examples, the engines of system 400 may apply splitting based on breakpoint values, as described above, to non-leaf nodes all the way up the tree, such that non-leaf nodes having non-leaf node children have no more than one non-leaf node child having a representative hash that is one of the breakpoint values.

Also, in such examples, as described above in relation to FIGS. 1-3, update engine 428 may create a new non-leaf node and insert a target leaf node under the new non-leaf node, in response to determinations that the fingerprint (e.g., hash) of the target data portion is one of the breakpoint values and that the target insertion point is under a non-leaf node having a direct child leaf node with one of the breakpoint values as its fingerprint (e.g., hash). In some examples, DAG 140 may be a hash tree, while DAG 150 is a hash-based DAG, for example. In some examples, functionalities described herein in relation to FIG. 4 may be provided in combination with functionalities described herein in relation to any of FIGS. 1-3 and 5.

In other examples, instructions 472 of client computing device 450 may construct a fingerprint-based DAG 140 to represent data collection 465 to be backed up in backup system 400, and selectively provide fingerprints of DAG 140 to backup system 400 for de-duplication comparison. In such examples, instructions 472 may acquire indications of which fingerprints are not found in a previously stored DAG 150 of backup system 400 and, based on these indications, may determine which data portions to provide to backup system 400 for backup, to thereby implement de-duplication. Such examples of instructions 472 are described herein in relation to method 500 of FIG. 5. However, in some examples, client computing device 450 of FIG. 4 may perform other methods different than method 500 of FIG. 5, or a subset of method 500, and method 500 of FIG. 5 may be performed by computing device(s) or system(s) other than computing device 450.

FIG. 5 is a flowchart of an example method 500 for providing data portions to a remote backup system for storage based on comparison results. At 505 of method 500, instructions 472 of client computing device 450 may determine a target data portion 170 and other data portions of a collection of data 465 stored in the client computing device and to be backed up in a remote backup system 400. In examples described herein, a “remote” backup system is a backup system separate from, but accessible over a computer network to, a client device to provide data for persistent storage.

At 505, instructions 472 may determine a target insertion point in a hash tree for a target leaf node representing the target data portion, the hash tree comprising non-leaf nodes and other leaf nodes representing, in a sorted order, the other data portions. As one example, instructions 472 may determine a target insertion point 248 in a hash tree 420 of FIG. 2A, as described above in relation to FIGS. 1-3. At 515, instructions 472 may determine a target hash of the target data portion.

At 520, in response to determinations that the target hash is one of a predefined plurality of breakpoint values and that the target insertion point is between two of the other leaf nodes having a common non-leaf node parent, instructions 472 may split the common non-leaf node parent, regardless of whether the common non-leaf node is full, as described above. At 525, instructions 472 may update the hash tree, including inserting the target leaf node under a non-leaf node resulting from the splitting, as described above. The updating may include further updates up the tree, as described above.

At 530, instructions 472 may iteratively provide one or more representative hashes of nodes of the hash tree to the remote backup system 400 via a network interface, starting with a representative hash of a root node of the hash tree. In some examples, instructions 472 may begin providing representative hashes to system 400 after the update(s) at 525, without any further updates to the hash tree, or after additional updates to the hash tree (e.g., further insertions and other updates, etc.).

At 535, instructions 472 may provide one or more of the target and other data portions represented in the hash tree to remote backup system 400 for storage based on comparison results received in response to the provided representative hash values.

For example, in response to receiving a comparison result from system 400 indicating that a representative hash of a given non-leaf node of the hash tree was not found in the remote backup service, instructions 472 may provide the representative hash of each child of the given node to remote backup service 400 for comparison. In response to receiving a comparison result indicating that a representative hash value of a given leaf node of the hash tree was not found in the remote backup service, instructions 472 may provide the data portion represented by the given leaf node to remote backup service 400 for storage in persistent storage 414. Also, in response to receiving a comparison result indicating that a representative hash value of a node of the hash tree was found in the remote backup system, instructions 472 may not provide the representative hash of any child of the node to remote backup system 400, and determine that each data portion in the sub-tree rooted at that node (or data portion represented by that leaf node) has previously been stored in system 400, and may not provide any data portion represented by that sub-tree for storage. In this manner, in such examples, client computing device 450 may utilize representative hashes of the hash tree to perform de-duplication based on the highest-level matches found in the tree, and provide, for persistent storage, data portions not found in the hash tree.

Although the flowchart of FIG. 5 shows a specific order of performance of certain functionalities, method 500 is not limited to that order. For example, the functionalities shown in succession in the flowchart may be performed in a different order, may be executed concurrently or with partial concurrence, or a combination thereof. In some examples, functionalities described herein in relation to FIG. 5 may be provided in combination with functionalities described herein in relation to any of FIGS. 1-4. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. An article comprising at least one non-transitory machine-readable storage medium comprising de-duplication instructions executable by a processing resource of a computing device to:
acquire, via a network interface device, a target data portion to be backed up in a backup system;
determine a target insertion point in a fingerprint-based directed acyclic graph (DAG) for a target leaf node representing the target data portion, the DAG comprising non-leaf nodes, and other leaf nodes representing, in a sorted order, other data portions to be backed up;
determine whether a content-based fingerprint of the target data portion is one of a plurality of predefined breakpoint values;
in response to determinations that the fingerprint is one of the breakpoint values and that the target insertion point is between two of the other leaf nodes having a common non-leaf node parent, split the common non-leaf node parent into multiple non-leaf nodes;
update the DAG, including inserting the target leaf node under one of the non-leaf nodes resulting from the split; and
compare the updated DAG, with or without further updates, to a previously stored DAG to determine whether the target data portion was previously stored in persistent storage of the backup system.

2. The article of claim 1, wherein:
each of the leaf nodes comprises a content-based fingerprint of the data portion it represents; and
the instructions are executable to create and update the DAG comprising the other leaf nodes such that each non-leaf node has no more than one direct child leaf node having a content-based fingerprint that is one of the breakpoint values.

3. The article of claim 2, wherein the de-duplication instructions are executable to:
in response to determinations that the fingerprint of the target data portion is one of the breakpoint values and that the target insertion point is at an end of a non-leaf node having a direct child leaf node with one of the breakpoint values as its content-based fingerprint, create a new non-leaf node and insert the target leaf node under the new non-leaf node.

4. The article of claim 1, wherein the instructions to split comprise instructions to:
in response to the determinations that the fingerprint is one of the breakpoint values and that the target insertion point is between other leaf nodes with a common non-leaf node parent, split the common non-leaf node parent into multiple non-leaf nodes regardless of whether the common non-leaf node is full.

5. The article of claim 1, further comprising instructions to:
in response to a determination that the target data portion has not been previously stored in persistent storage of the backup system, based on the previously stored DAG, store the target data portion in a memory device of the persistent storage.

6. The article of claim 1, wherein:
each content-based fingerprint is a hash of a respective one of the target and other data portions; and
the DAG comprising the other leaf nodes is a hash tree.

7. The article of claim 1, wherein the instructions to determine the target insertion point comprise instructions to:
determine that the target leaf node is to be inserted, in the sorted order of the other leaf nodes, between two of the other leaf nodes having different parent non-leaf nodes, the different parent non-leaf nodes being first and second non-leaf nodes of the plurality of non-leaf nodes;
determine whether the first non-leaf node is full; and
in response to determinations that the first non-leaf node is not full and that the fingerprint of the target data portion is not one of the breakpoint values, determine the target insertion point to be under the first non-leaf node.

8. The article of claim 7, wherein the instructions to determine the target insertion point comprise instructions to:
in response to at least one of a determination that the first non-leaf node is full and a determination that the fingerprint of the target data portion is one of the breakpoint values, determine the target insertion point to be under the second non-leaf node;
wherein the instructions to update the DAG further comprise instructions to determine whether to insert the target leaf node under the second non-leaf node or to create a new non-leaf node for the target leaf node, based on at least one of whether the second non-leaf node is full and whether the second non-leaf node has a direct child leaf node with one of the breakpoint values as its content-based fingerprint.

9. A backup system comprising:
an acquisition engine to acquire, with a network interface device, a target data portion and other data portions to be backed up in the backup system;
a target engine to determine a target insertion point in a fingerprint-based directed acyclic graph (DAG) for a target leaf node representing the target data portion, the DAG comprising non-leaf nodes and other leaf nodes representing, in a sorted order, the other data portions;
a breakpoint engine to determine whether a hash of the target data portion is one of a plurality of predefined breakpoint values;
a determine engine to, in response to determinations that the hash is one of the breakpoint values and that the target insertion point is between two of the other leaf nodes having a common non-leaf node parent, to split the common non-leaf node regardless of whether the common non-leaf node is full;
an update engine to update the DAG, comprising inserting the target leaf node under one of the non-leaf nodes resulting from the split; and
a store engine to store, in persistent storage of the backup system, each of the target and other data portions determined not to be previously stored in the backup system based on a comparison of the updated DAG, with or without further updates, with a previously stored DAG.

10. The system of claim 9, wherein:
the DAG comprising the other leaf nodes is a hash tree;
each of the leaf nodes comprises a hash of the data portion it represents; and
each non-leaf node comprises a representative hash representing the content of each child sub-tree under it, wherein the system is to update the representative hash when a child sub-tree under the non-leaf node is modified.

11. The system of claim 10, further comprising:
a compare engine to determine which of the target and other data portions were previously stored in the backup system by comparing the representative hashes of one or more non-leaf and leaf nodes of the hash tree to representative hashes of nodes of the previously stored DAG;
wherein the comparing comprises traversing down the hash tree starting from the root and, for each traversed node, comparing the representative hash of the node to at least one representative hash of at least one node of the previously stored DAG to find highest level nodes of the hash tree that are represented in the previously stored DAG.

12. The system of claim 10, wherein the system is to create and update the hash tree such that each non-leaf node has no more than one direct child leaf or direct child non-leaf node whose representative hash is one of the breakpoint values.

13. The system of claim 12, wherein the determine engine is further to:
in response to determinations that the hash of the target data portion is one of the breakpoint values and that the target insertion point is under a non-leaf node having a direct child leaf node with one of the breakpoint values as its hash, create a new non-leaf node and insert the target leaf node under the new non-leaf node.

14. A method comprising:
determining, by a client computing device, a target data portion and other data portions of the client computing device to be backed up in a remote backup system;
determining a target insertion point in a hash tree for a target leaf node representing the target data portion, the hash tree comprising non-leaf nodes and other leaf nodes representing, in a sorted order, the other data portions;
determining a target hash of the target data portion;
in response to determinations that the target hash is one of a plurality of predefined breakpoint values and that the target insertion point is between two of the other leaf nodes having a common non-leaf node parent, splitting the common non-leaf node parent, regardless of whether the common non-leaf node is full;
updating the hash tree, comprising inserting the target leaf node under a non-leaf node resulting from the split;
iteratively providing one or more representative hashes of nodes of the hash tree, with or without further updates, to the remote backup system via a network interface device; and
providing one or more of the target and other data portions to the remote backup system for storage based on comparison results received in response to the provided representative hash values.

15. The method of claim 14, further comprising:
in response to receiving a comparison result indicating that a representative hash of a given non-leaf node of the hash tree was not found in the remote backup service, providing the representative hash of a child of the given node to the remote backup service; and
in response to receiving a comparison result indicating that a representative hash of a given leaf node of the hash tree was not found in the remote backup service, providing the data portion represented by the given leaf node to the remote backup service for storage.
